(19) United States
(12) Patent Application Publication
(10) Pub. No.: US 2010/0158337 A1
(43) Pub. Date: Jun. 24, 2010

(54) METHOD AND DEVICE FOR PERFORMING A COMPARISON BETWEEN A LEFT AND A RIGHT HALF OF THE BRAIN OF A PATIENT

(76) Inventors: Corinna Bürger, Erlangen (DE); Heinz Fichte, Herzogenaurach (DE); Grzegorz Soza, Nurnberg (DE)

Correspondence Address: HARNESS, DICKEY & PIERCE, P.L.C., P.O.BOX 8910, RESTON, VA, 20195, US

(21) Appl. No.: 12/639,089

(22) Filed: Dec. 16, 2009

(30) Foreign Application Priority Data
Dec. 17, 2008 (DE) 10 2008 062 672.4

(51) Int. Cl. G06K 9/00

(52) U.S. Cl. 382/131

(57) ABSTRACT

In order to compare a left and a right half of the brain of a patient on the basis of medical 2D or 3D image data records for determining the perfusion, the brain of the patient is subdivided into brain regions, wherein the number of brain regions is an even number n, a number n/2 of the brain regions being arranged in the right half of the brain and a number n/2 of the brain regions being arranged in the left half of the brain, with each of the brain regions arranged in the right half of the brain being unambiguously assigned to a brain region arranged in the left half of the brain, and the brain being subdivided by planes standing perpendicularly on a median sagittal plane. In at least one embodiment, the image data records are segmented, wherein brain image data records are generated which only include those picture elements of the image data records which represent the brain of the patient. In at least one embodiment, n partial image data records are determined in each of the brain image data records, wherein an m-th partial image data record only include those picture elements of the respective brain image data record, which represent an m-th of the n brain regions, with m=1 . . . n. In at least one embodiment, one or more characteristic values are calculated per m-th brain region by evaluating all m-th partial image data records according to a prescribed evaluation method. Finally, in at least one embodiment, the characteristic values of brain regions unambiguously assigned to one another are evaluated according to predetermined criteria for comparing the right and left half of the brain.

### PRIORITY STATEMENT

The present application hereby claims priority under 35 U.S.C. §119 on German patent application number DE 10 2008 062 672.4 filed Dec. 17, 2008, the entire contents of which are hereby incorporated herein by reference.

### FIELD

At least one embodiment of the present invention lies in the field of medical technology and describes a method and/or a device for performing a comparison between a left and a right half of the brain of a patient. An important field of the application of at least one embodiment of the invention lies in stroke diagnosis and, in particular, in the evaluation and appraisal of image data, or time series of the image data, obtained by scanning the head of a patient using perfusion computed tomography (perfusion CT; PCT) or perfusion magnetic resonance imaging (perfusion MRI; P-MRI).

### BACKGROUND

Perfusion CT has developed significantly in recent years, particularly as a result of the introduction of the multi-slice spiral technique, the use of lower injection rates and as a result of improved evaluation software. Perfusion CT can quantitatively determine the cerebral blood flow, can be performed quickly, is cost-effective and puts little strain on the patient and has therefore established itself over perfusion MRI. It is for this reason that nowadays it is routinely used in hospitals. Perfusion CT offers two decisive advantages in stroke diagnosis: areas of the brain with a perfusion disorder (blood supply disorder) can be detected directly after the start of clinical symptomatology without time delay and native CT images, together with the parameter images from perfusion CT, allow a distinction to be made between the already irreversibly damaged infarct core and the potentially only reversibly disordered infarct penumbra.

This affords the possibility of stroke therapy which, beyond fixed therapeutic timeframes, can take the individual perfusion situation of the patient into account.

In order obtain functional information relating to the cerebral blood flow (cerebral perfusion), a brief intravenous contrast agent bolus is supplied in perfusion CT, and at the same time a time series of 2D or 3D image data is acquired, typically at fixed time intervals.

The evaluation of the time series of the 2D or 3D image data obtained during perfusion CT is based on the indicator dilution theory. After the bolus-type administration of an intravenous contrast agent, the X-ray density of the perfused brain regions increases temporarily. Conclusions about the cerebral perfusion can be drawn from the extent and the time profile of the increase of the X-ray density. To this end, parameters are computed using various mathematical algorithms, which parameters describe the cerebral perfusion and can be illustrated in the form of color-coded parameter images. Thus most commonly used parameters are the cerebral blood flow (CBF), the cerebral blood volume (CBV) and the parameters for describing a perfusion delay: the mean transit time (MTT) and the time to peak (TTP). In the following text, the aforementioned parameters are briefly explained individually.

The cerebral blood flow (CBF) is the most important parameter of cerebral perfusion. It specifies how much blood flows through the cerebral tissue in a given period of time, and is measured in [ml blood/100 g brain tissue/min]. Normal values for CBF in a healthy human lie in the range of between 50 and 80 ml blood per 100 g cerebral tissue and minute. In a healthy state, regions of the brain with high energy requirements, such as the surface of the cortex or the basal ganglia, have CBF values which are about 1 to 3 times higher than, for example, white matter. The cerebral perfusion is regulated by autoregulation by constantly changing the vessel diameters and is kept fairly constant. If the perfusion pressure increases, for example in the case of increased systemic blood pressure, the cerebral vessels constrict and said vessels dilate if the pressure falls. The CBF only decreases if the vessels in a certain region of the brain are already maximally dilated and the perfusion pressure continues to fall.

The synaptic function of the nerve cells is suspended due to lack of energy if the CBF falls below 10 ml/100 g/min, i.e. there is neurological failure. However, this failure can be completely reversible once the perfusion normalizes again. A CBF of below 10-15 ml/100 g/min means that it also no longer possible to maintain the structural metabolism of the nerve cells. If the CBF remains below this so-called ischemia threshold for approximately 2-10 minutes, this leads to irreversible cell damage. However, the above-mentioned specifications in respect of the level of the CBF should only be considered to be approximate guidelines in the interpretation of perfusion examinations. The calculated local CBF varies not only as a function of the software used for the evaluation, but can also, depending on the methodology, be varied by, for example, the injection speed of the contrast agent bolus or a reduced cardiac function of the patient. Moreover, the CBF values of white matter are significantly below those of gray matter. Partial volume effects cannot be avoided as a result of the limited spatial resolution of the method.

The cerebral blood volume (CBV) is defined as the proportion, in percent, of blood vessels in a certain tissue volume. Strongly vascularized areas of the brain such as the basal ganglia or the surface of the cortex therefore have a higher CBV than, for example, the little vascularized cerebral white matter. However, the CBV is also a functional parameter and changes when the vessel width changes within the scope of vascular autoregulation. In contrast to the CBF, which is reduced in both the infarct core and the penumbra in the case of ischemia, the CBV generally increases in the penumbra. This is caused by the cerebral autoregulation. The fall-off in CBF is intended to be compensated for by a wide position of the affected vessels. In contrast thereto, the irreversibly damaged infarct core generally no longer has functioning autoregulation either and so the CBV is reduced. This is very useful in stroke diagnosis: areas which have a reduced CBV during the acute stage of ischemia are generally irreversibly damaged.

Of those parameters which indicate a perfusion delay, the mean transit time (MTT) and the time to peak (TTP) are the most commonly used. There is a direct relationship between said parameters and the cerebral perfusion pressure. A small impairment of the blood supply already leads to an increase in MTT and TTP. Clinical studies of strokes have shown that MTT and TTP are very sensitive to disorders of the regional cerebral perfusion. However, they are not specific to ischemia. Pathological MTT and TTP values are found both in the infarct core and in the penumbra, but can also be caused by a clinically asymptomatic upstream vessel stenosis (for example in the internal carotid artery) or by a vasospasm.

Within the scope of evaluating the CT image data records, present as a time series, for determining the perfusion, it is necessary, in part, to compare or evaluate, according to predetermined criteria, the right and left half of the brain on the basis of the CT image data records or of data derived therefrom, for example for normalizing the parameter images (CBF, CBV, MTT or TTP) to be generated. Thus, the calculated parameter data is often normalized with respect to that half of the brain which has the higher blood through-flow. In the prior art, this is effected by parameter images for CBF, CBV or TTP being preliminarily computed and displayed. An operator, usually a radiologist, performs the comparison by examining the displayed preliminary parameter images and enters the result into the image evaluation system for the final calculation of the parameter images. This procedure requires calculating preliminary parameter images and therefore takes a lot of time. Furthermore, it is prone to errors and can, in part, not be reproduced precisely because of the required intervention by the operator.

The document EP 1 946 703 A1 discloses a method and a device for evaluating image data. A 2D image data record, for example a 2D perfusion image data record, in which a symmetric organ is formed is provided for the method. This image data record is first of all segmented and so the organ tissue of interest is obtained in a segmented 2D image data record. Subsequently, an axis of symmetry is calculated in the segmented 2D image data record. Furthermore, regions in the segmented 2D image data record are fixed on both sides of the axis of symmetry, the image data values contained in these regions being analyzed in a further step and being compared with one another in regions lying on both sides of the symmetry axis, which regions are assigned to one another. The described method is particularly suitable for analyzing strokes.

The document US 2004/0106864 A1 discloses a method in which diffusion and perfusion image data records generated by MRI are used to automatically estimate the brain volume affected by a stroke.

Finally, the document DE 10 2007 024 450 A1 discloses a calculation method for the quantitative analysis of coronary angiographic image series for determining myocardial perfusion. The method disclosed therein provides an option for easier recognition of the blood flow in vessels.

### SUMMARY

At least one embodiment of the invention is directed to specifying an improved method and/or a device for performing a comparison between a left and a right half of the brain of a patient.

Advantageous developments of the method according to at least one embodiment of the invention and the device according to at least one embodiment of the invention can be gathered from the dependent claims, the subsequent description, the example embodiment and the figures.

The method according to at least one embodiment of the invention comprises the following steps: In step 1.1., a time series with a number p of 2D or 3D image data records for determining the perfusion is provided, in which in each case a head of the patient with a brain comprising the right and the left half of the brain (hemisphere) is imaged, and which image data records in each case comprise a multiplicity of picture elements with assigned picture element values. The 2D or 3D perfusion image data records were preferably generated by perfusion computed tomography or perfusion magnetic resonance imaging. The provision is effected in a storage medium, in particular in the memory of a post-processing workstation. This description assumes that the patient does not move during the scan of said patient's head by means of a medical imaging system (e.g. a CT or MRI system) and so the spatial assignment of a picture element (pixel, voxel) to an object element (pixel, voxel) does not change for the 2D or 3D image data records acquired at different times. If the patient should have moved between the recordings of individual 2D or 3D image data records, appropriate image registration should preferably be undertaken.

In step 1.2., the brain of the patient is subdivided into brain regions, wherein the number of brain regions is an even number n, a number n/2 of the brain regions being arranged in the right half of the brain and a number n/2 of the brain regions being arranged in the left half of the brain, with each of the brain regions arranged in the right half of the brain being unambiguously assigned to a brain region arranged in the left half of the brain, and the brain being subdivided by planes standing perpendicularly on a median sagittal plane (MSP). Herein, the term unambiguously is understood to mean a bijective assignment. This ensures that each half of the brain has the same number of brain regions and that the brain regions are assigned to one another in pairs. Step 1.2. can be performed parallel to or before step 1.1. The subdivision of the patient's brain can be predetermined in various ways. By way of example, a subdivision from a plurality of subdivisions of a model brain can be selected manually or automatically and this subdivision is then transferred to the patient's brain; or a concrete subdivision of the patient's brain can be predetermined by an interactive input on the basis of one of the 2D or 3D perfusion image data records. The brain is preferably subdivided into brain regions corresponding to anatomical brain structures. In such a case, the subdivision could comprise the following regions in each half of the brain: frontal lobe, parietal lobe, temporal lobe, cerebellum and occipital lobe.

So that the method of at least one embodiment operates in an economical fashion in respect of calculation time, the brain is preferably only subdivided into two, four, six or eight brain regions overall. Experiments by the inventors revealed that an approximate subdivision into three brain regions per half of the brain already supplies very good results. As the number of regions increases, this leads to an increase in both the computational complexity and the resolution, and hence the detail of the ultimately sought after comparison between the two brain halves. In this respect, the number of brain regions should be optimized depending on the requirements. Deviating from a subdivision according to anatomical brain structures, any arbitrary subdivision of the brain into regions can be predetermined within the scope of the features of step 1.2. The perpendicularly standing planes are preferably coronal planes and/or transverse planes. Note: the body planes are the transverse plane, the coronal plane and the sagittal plane.

It is particularly advantageous if the predetermined brain regions are respectively arranged in the vicinity of a brain surface. Moreover, it is advantageous if there is no overlap between the brain regions.

The p image data records are segmented in step 1.3. such that one brain image data record is generated per image data record, which brain image data record only comprises those picture elements of the image data record which represent the brain.

Conventional segmentation methods known from the prior art are suitable for segmentation. In the present case, the segmentation is not required to be very precise and so simple segmentation methods can also be used. In general, the brain image data record comprises picture elements (pixel, voxel) which represent the brain. In the present case, the brain is first of all understood to be any tissue which is not the skull. In certain applications it is moreover advantageous for the generated brain image data records to represent the brain without ventricles and/or blood vessels. Thus, after step 1.3. was performed, there is a time series of p brain image data records, wherein the brain of the patient with its right and left half of the brain is imaged in each brain image data record.

In step 1.4., n partial image data records are determined in each of the p brain image data records, wherein an m-th partial image data record only comprises those picture elements of the respective brain image data record, which represent an m-th of the n brain regions, with m=1 . . . n. Thus, those picture elements of the respective brain image data record are assigned to each partial image data record, which picture elements correspond to one of the predetermined brain regions. Remaining within the preceding example of an anatomically motivated subdivision of the brain, this means that, for example, a partial image data record is generated which comprises all picture elements which represent the left frontal lobe, a further partial image data record is generated which comprises all picture elements which represent the right frontal lobe, etc. Thus, in turn, there is a corresponding time series for each of the n partial image data records of a first brain image data record. The number n corresponds to the number of brain regions n in step 1.2.

The partial image data records in the brain image data records are preferably determined using a segmentation method and/or pattern recognition method. In a preferred embodiment variant, the median sagittal plane is calculated in the respective brain image data records. Thus, the image volume in the respective brain image data records can be divided into two halves, with one half corresponding to the right half of the brain and the other half corresponding to the left half of the brain. Further determining of the partial image data records can in this case be performed on the basis of, for example, simple geometric prescriptions from step 1.2.

In step 1.5., one or more characteristic values per m-th brain region are calculated by evaluating all m-th partial image data records for m=1 . . . n according to a prescribed evaluation method. It goes without saying that there are a multiplicity of conceivable evaluation methods for this step.

In accordance with an example evaluation method, for each of the p brain image data records, a characteristic variable is calculated per m-th partial image data record comprised therein, with m=1 . . . n. By way of example, such a characteristic variable is the average value or a weighted average value of the picture element values of a respective partial image data record. It is possible that, depending on the respective question or statement of the problem, different algorithms for determining the characteristic variable are selected. Here, the characteristic variable preferably results by taking account of all picture element values of a partial image data record. Thus, a corresponding characteristic variable is assigned to all partial image data records. Subsequently, a time series of the characteristic variable is determined from said characteristic variable per brain region on the basis of the time information assigned to the individual brain image data records and hence to the individual partial image data records. In a final step of this evaluation method, one or more characteristic values which characterize a respective time series are calculated per previously calculated characteristic variable time series.

In a second example evaluation method, time series of the corresponding picture elements are calculated in step 1.5. for every object pixel/voxel (which represent the head of patient in the object space) on the basis of the p brain image data. In a second step, these time series of image pixels/voxels are averaged for each of the n brain regions. Hence, there is one time series of a characteristic variable per brain region, as is the case in the previously described evaluation method. In the final step of this evaluation method, as before, one or more characteristic values which characterize a respective time series are calculated per previously calculated characteristic variable time series. The term time series should in the present case also be understood to include a function which describes the temporal behavior of the characteristic values.

A maximum value of a respective time series is preferably selected to be a characteristic value. A time at which the maximum value is attained in a respective time series is preferably determined as a characteristic value or a further characteristic value.

In a particularly advantageous refinement of the method, step 1.5. includes calculating one or more characteristic values for characterizing arterial vessels imaged in a partial image data record. Of course, this is only possible if the arterial vessels were not removed by the segmentation in step 1.3., that is to say if the brain image data records, and hence also the partial image data records, comprise picture elements which represent vessels, in particular arteries. By way of example, in such a case the number of picture elements (pixel, voxel) which represent arterial vessels can in each case be selected as the characteristic value of a partial image data record.

In step 1.6., the characteristic values of brain regions unambiguously assigned to one another according to predetermined criteria are evaluated for comparing the right and left half of the brain. The criteria are predetermined appropriately in accordance with the respective question or statement of the problem.

Two brain regions G1 and G2, unambiguously assigned to one another, are examined as an example. Two characteristic values K1, K2 (i.e. K1(G1), K1(G2), K2(G1) and K2(G2)) have been calculated for each brain region. In the simplest case, the evaluation of the characteristic values first of all corresponds to determining a relation between the respective characteristic values, i.e. whether the characteristic value K1(G1) is greater than, less than or equal to the characteristic value K1(G2), or whether the characteristic value K2(G1) is greater than, less than or equal to the characteristic value K2(G2). Initially, 0 points are assigned to each brain region. If a points system is now prescribed, according to which it is always that brain region (G1 or G2) that receives a point for which the higher/lower characteristic value was calculated in such a comparison, a simple comparison of the two hemispheres of the brain can be performed on the basis of the points allocated for the respective brain regions after all brain regions have correspondingly been evaluated. The method according to at least one embodiment of the invention or the above-described method steps can preferably be performed automatically.

The method according to at least one embodiment of the invention is advantageous over the prior art in the following respects: The subdivision of the brain into individual brain regions makes a more detailed and robust comparison between the two halves of the brain (hemispheres of the brain) possible; the evaluation of pixels or voxels in the brain image data which represent the arteries permits a simple comparison of the hemispheres of the brain in respect of the earliest enhancement thereof; the computation of preliminary parameter images is no longer necessary for normalizing parameter images within the scope of perfusion imaging.

The part of the object relating the device is achieved by a device as per claim 16.

A device is described, in at least one embodiment, for performing a comparison between a left and a right half of the brain of a patient, comprising: a storage medium used for storing and providing a time series with a number p of 2D or 3D image data records for determining the perfusion, in which in each case a head of the patient with a brain comprising the right and the left half of the brain is imaged, and which image data records in each case comprise a multiplicity of picture elements with assigned picture element values, a first module which can predetermine a subdivision of the brain of the patient into brain regions, wherein the number of brain regions corresponds to an even number n, a number n/2 of the brain regions being arranged in the right half of the brain and a number n/2 of the brain regions being arranged in the left half of the brain, with each of the brain regions arranged in the right half of the brain being unambiguously assigned to a brain region arranged in the left half of the brain, and the brain (2) being subdivided by planes standing perpendicularly on a median sagittal plane (MSP), a second module which segments the p image data records such that one brain image data record is generated per image data record, which brain image data record only comprises those picture elements of the image data record which represent the brain of the patient, a third module which determines n partial image data records in each of the p brain image data records, wherein an m-th partial image data record only comprises those picture elements of the respective brain image data record, which represent an m-th of the n brain regions, with m=1 . . . n, a fourth module which calculates one or more characteristic values per m-th brain region by evaluating all m-th partial image data records in the p brain image data records according to a prescribed evaluation method, with m=1 . . . n, and a fifth module which evaluates the characteristic values of brain regions unambiguously assigned to one another according to predetermined criteria for comparing the right and left half of the brain.

The statements made above in respect of the method according to at least one embodiment of the invention also hold true analogously for the device according to the invention. In this respect, reference is made to the above remarks in respect of the method according to at least one embodiment of the invention.

### BRIEF DESCRIPTION OF THE DRAWINGS

The device according to at least one embodiment of the invention can be used in particular for determining that half of the brain of a patient which is affected by a stroke. More detailed remarks in respect thereof can be gathered from the following example embodiment. In the figures,

FIG. 1 shows a two dimensional slice in a transverse plane through the brain of a patient, the brain being subdivided into six brain regions,

FIG. 2 shows a characteristic variable time curve for brain region G1; and

FIG. 3 shows a characteristic variable time curve for brain region G2.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

As an example embodiment, the present method is used to determine the hemisphere of the brain of a patient affected by a stroke. First of all, provision is made for a time series of 3D CT image data records for determining the perfusion.

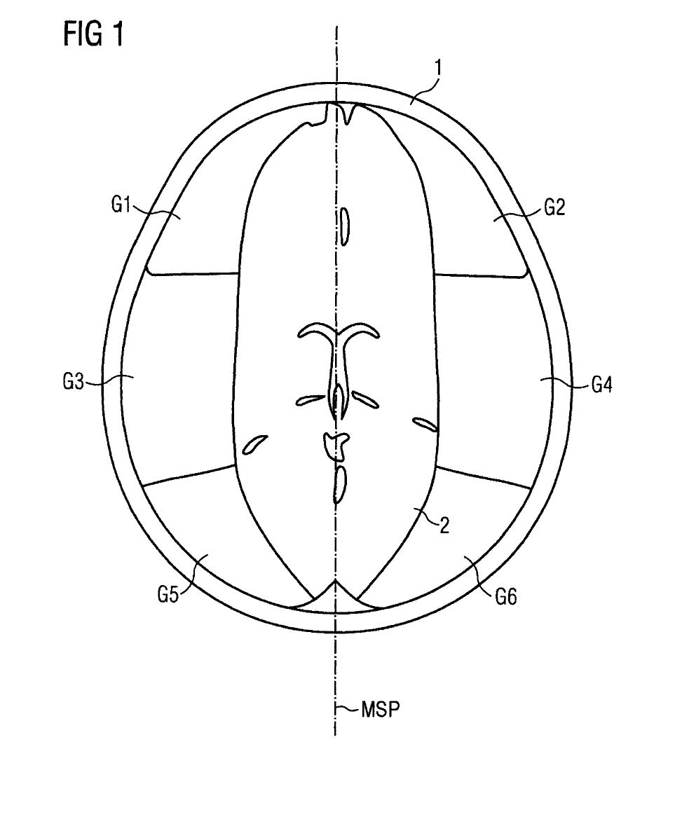

To this end, FIG. 1 shows a transverse slice image of one of the 3D CT image data records. The brain 2 of the patient surrounded by the skull 1 and with the subsequently described subdivision into brain regions (G1-G6) is visible.

In the present case, the brain 2 of the patient was subdivided into six brain regions G1-G6, which approximately represent different anatomical regions of the brain 2. Here, the brain regions G1-G6 are assigned to one another as follows: G1-G2, G3-G4, G5-G6. FIG. 1 shows that it is not necessary for the whole brain to be subdivided into brain regions. In the present example embodiment, the central regions of the brain which lie close to the median sagittal plane MSP are not taken into account in the comparison. As a matter of principle, the assignment is effected such that anatomically or functionally equivalent brain regions are assigned to one another. Thus, the number of brain regions corresponds to the even number n=6, a number n/2=3 of the brain regions being arranged in the right half of the brain and a number n/2=3 of the brain regions being arranged in the left half of the brain and each of the brain regions arranged in the right half of the brain is unambiguously assigned to a brain region arranged in the left half of the brain.

In the next step, the provided 3D CT image data records are segmented and so one brain image data record is generated per image data record, which brain image data record only comprises those picture elements of the image data record which represent the brain 2 of the patient, with the skull 1 and the ventricles being removed by segmentation using conventional, e.g. threshold value-based, methods. Exact segmentation in these areas is complicated and not necessary in this case. Experiments have shown that three approximate sub-regions suffice for every hemisphere of the brain. The slice planes which subdivide the brain regions G1-G6 preferably stand perpendicularly on the plane (median sagittal plane; MSP) which separates the two hemispheres of the brain from one another.

In the next step, n=6 partial image data records are determined in each of the brain image data records, wherein an m-th partial image data record only comprises those picture elements of the respective brain image data record, which represent an m-th of the n=6 brain regions, with m=1 . . . 6.

A so-called time attenuation curve (TAC), i.e. the time profile of an X-ray attenuation value averaged for the respective brain region, is now computed for each of the brain regions G1-G6 by evaluating all brain image data records. In this case, the vessels are excluded from the TAC calculation.

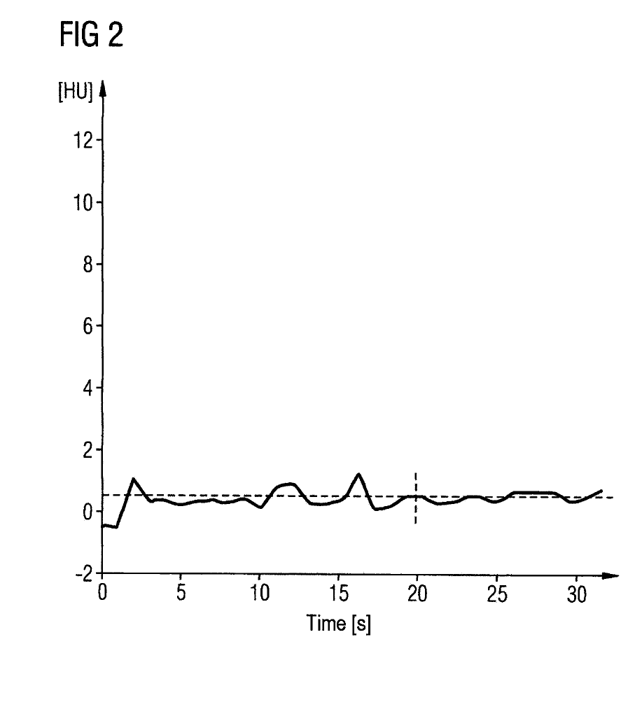

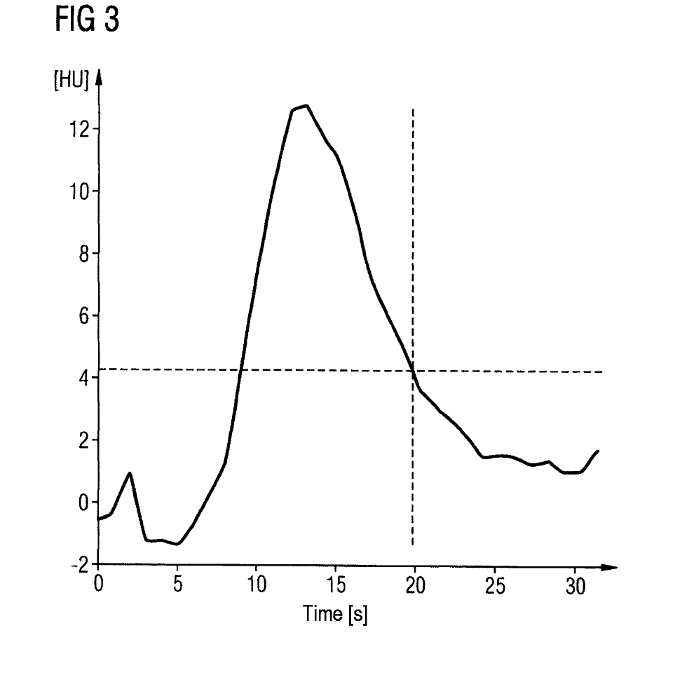

FIG. 2 and FIG. 3 respectively show such a TAC for the brain regions G1 (FIG. 2) and G2 (FIG. 3) which are assigned to one another. In each case, the curve corresponds to the X-ray attenuation value (y-axis) plotted over time (x-axis). It can clearly be seen that in FIG. 2 the X-ray attenuation value remains approximately constant over time, and hence no effects of the contrast agent injected during the acquisition of the 3D CT perfusion image data records can be found in this brain region. This is a clear indication of a disorder in the blood flow. In contrast thereto, a significant effect of the contrast agent is shown in FIG. 3. The following characteristic values are determined for each of the six calculated TACs (one for each brain region):

1. The maximum X-ray attenuation value of the TAC, and
2. the time at which the TAC reaches the maximum thereof.

On the basis of these characteristic values, the brain regions G1-G2, G3-G4, G5-G6 unambiguously assigned to one another are, in the final step, evaluated according to predetermined criteria for comparing the right and left half of the brain.

So as to be able to compare for each of the six brain regions G1-G6 in which hemisphere an enhancement (an increase in the X-ray density caused by the contrast agent) occurs first, it is possible to use an evaluation algorithm which determines the arterial vessels in the brain image data. This algorithm calculates, for example for the entire brain, approximately those 5% of the vessels which are enhanced first. Since the arteries are mainly in the front region of the brain, it is sufficient to only use the upper regions for the evaluation. Subsequently, the number of pixels/voxels marked as arteries are counted for each hemisphere of the brain.

A simple points system is used in order to make a final decision as to in which half of the brain a stroke is present. Here, respectively unambiguously mutually assigned brain regions are compared for each of the two above-mentioned characteristic values. Initially, each hemisphere of the brain is assigned 0 points. That half of the brain with the higher maximum X-ray attenuation value, or with the shorter time until the TAC reaches the maximum thereof, in the comparison is allocated one point. The hemisphere which has collected the most points is selected to be the “healthy” hemisphere of the brain. The sought after hemisphere of the brain with the stroke is that hemisphere with the fewest number of points. If the scores are precisely the same, no statement is made.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for performing a comparison between a left and a right half of the brain of a patient, comprising:
providing a time series with a number p of medical 2D or 3D image data records for determining the perfusion, wherein a head of the patient with a brain comprising a right and a left half of the brain is imaged to create each of the image data records, and wherein each of the image data records comprise a multiplicity of picture elements with assigned picture element values;
determining a subdivision of the brain of the patient into brain regions, wherein a number of the brain regions is an even number n, a number n/2 of the brain regions being arranged in the right half of the brain and a number n/2 of the brain regions being arranged in the left half of the brain, with each of the brain regions arranged in the right half of the brain being unambiguously assigned to a brain region arranged in the left half of the brain, and with the brain being subdivided by planes standing perpendicularly on a median sagittal plane;
segmenting the p image data records such that one brain image data record is generated per one of the p image data records, the brain image data record only comprising picture elements of the image data record which represent the brain of the patient;
determining n partial image data records in each of the p brain image data records, wherein an m-th partial image data record only comprises picture elements of the respective brain image data record, which represent an m-th of the n brain regions, with m=1 . . . n;
calculating one or more characteristic values per m-th brain region by evaluating all m-th partial image data records in the p brain image data records according to an evaluation method, with m=1 . . . n; and
evaluating the characteristic values of brain regions unambiguously assigned to one another according to criteria for comparing the right and left half of the brain.

2. The method as claimed in claim 1, wherein the calculating comprises:
calculating, for each of the p brain image data records, a characteristic variable per m-th partial image data record comprised therein, with m=1 . . . n,
calculating a time series of the characteristic variables per m-th brain region, with m=1 . . . n,
calculating one or more characteristic values, each for characterizing the calculated time series.

3. The method as claimed in claim 2, wherein each characteristic variable is an average value or a weighted average value of all picture element values of a respective partial image data record.

4. The method as claimed in claim 2, wherein a characteristic value is a maximum value in a respective time series.

5. The method as claimed in claim 2, wherein a characteristic value is a time at which the maximum value is attained in a respective time series.

6. The method as claimed in claim 1, wherein the calculating comprises:
calculating, per partial image data record, one or more characteristic values for characterizing arterial vessels imaged in the partial image data record.

7. The method as claimed in claim 6, wherein the characteristic value is the number of picture elements in the partial image data record which represent arterial vessels.

8. The method as claimed in claim 1, wherein the brain regions do not overlap.

9. The method as claimed in claim 1, wherein the p image data records were generated by perfusion computed tomography or perfusion magnetic resonance imaging.

10. The method as claimed in claim 1, wherein the brain is determined to be subdivided into four, six or eight brain regions.

11. The method as claimed in claim 1, wherein the perpendicularly standing planes are coronal planes.

12. The method as claimed in claim 1, wherein the perpendicularly standing planes are transverse planes.

13. The method as claimed in claim 1, wherein the segmentation is performed such that the generated brain image data records represent the brain without at least one of ventricles and blood vessels.

14. The method as claimed in claim 1, wherein the calculating comprises calculating a median sagittal plane in the respective brain image data records.

15. The method as claimed in claim 1, wherein at least one of the steps of the method are performed automatically.

16. A device for performing a comparison between a left and a right half of the brain of a patient, comprising:
a storage medium adapted to store and provide a time series with a number p of medical 2D or 3D image data records for determining the perfusion, wherein a head of the patient with a brain comprising a right and a left half of the brain is imaged to create each of the image data records, and wherein each of the image data records comprise a multiplicity of picture elements with assigned picture element values;
a first module to determines a subdivision of the brain of the patient into brain regions, wherein a number of the brain regions is an even number n, a number n/2 of the brain regions being arranged in the right half of the brain and a number n/2 of the brain regions being arranged in the left half of the brain, with each of the brain regions arranged in the right half of the brain being unambiguously assigned to a brain region arranged in the left half of the brain, and with the brain being subdivided by planes standing perpendicularly on a median sagittal plane;
a second module adapted to segment the p image data records such that one brain image data record is generated per one of the p image data records, the brain image data record only comprising those picture elements of the image data record which represent the brain of the patient;
a third module adapted to determines n partial image data records in each of the p brain image data records, wherein an m-th partial image data record only comprises picture elements of the respective brain image data record, which represent an m-th of the n brain regions, with m=1 . . . n;
a fourth module adapted to calculate one or more characteristic values per m-th brain region by evaluating all m-th partial image data records in the p brain image data records according to an evaluation method, with m=1 . . . n; and
a fifth module adapted to evaluate the characteristic values of brain regions unambiguously assigned to one another according to criteria for comparing the right and left half of the brain.

17. The device as claimed in claim 16, wherein the fourth module is adapted to:
calculate, for each of the p brain image data records, a characteristic variable per m-th partial image data record comprised therein, with m=1 . . . n,
calculate a time series of the characteristic variables per m-th brain region, with m=1 . . . n, and
determine one or more characteristic values, in each case, for the purpose of characterizing the calculated time series.

18. The device as claimed in claim 16, wherein the fourth module is adapted to calculate, per partial image data record, one or more characteristic values for characterizing arterial vessels imaged in the partial image data record.

19. The device as claimed in claim 16, wherein the second module is adapted to perform the segmentation such that the generated brain image data records represent the brain without at least one of ventricles and blood vessels.

20. The device as claimed in claim 16, wherein the third module is adapted to calculate a median sagittal plane in every 3D brain image data record.

21. A method, comprising:
using the device as claimed in claim 16 for determining that half of the brain of a patient which is affected by a stroke.

22. The method as claimed in claim 3, wherein a characteristic value is a maximum value in a respective time series.

23. The method as claimed in claim 3, wherein a characteristic value is a time at which the maximum value is attained in a respective time series.

24. A computer readable medium including program segments for, when executed on a computer device, causing the computer device to implement the method of claim 1.

25. The device as claimed in claim 17, wherein the fourth module is adapted to calculate, per partial image data record, one or more characteristic values for characterizing arterial vessels imaged in the partial image data record.

26. The device as claimed in claim 17, wherein the second module is adapted to perform the segmentation such that the generated brain image data records represent the brain without at least one of ventricles and blood vessels.

27. The device as claimed in claim 17, wherein the third module is adapted to calculate a median sagittal plane in every 3D brain image data record.

28. A method, comprising:
using the device as claimed in claim 17 for determining that half of the brain of a patient which is affected by a stroke.
